(19) United States
(12) Patent Application Publication
(10) Pub. No.: US 2017/0210890 A1
(43) Pub. Date: Jul. 27, 2017

(54) A POLYETHYLENE BLEND COMPOSITION AND FILM MADE THEREFROM

(71) Applicant: Dow Global Technologies LLC, Midland, MI (US)

(72) Inventors: Teresa P. Karjala, Lake Jackson, TX (US); Jorge Caminero Gomes, Sao Paulo (BR)

(21) Appl. No.: 15/327,660

(22) PCT Filed: Jul. 14, 2015
(86) PCT No.: PCT/US2015/040290

§ 371 Date: Jan. 20, 2017

Related U.S. Application Data
(60) Provisional application No. 62/028,925, filed on Jul. 25, 2014.

(51) Int. Cl. C08L 23/08; B29C 47/00; B29B 9/06; C08J 5/18; B29B 7/20

(52) U.S. Cl. CPC C08L 23/0815; C08J 5/18; B29B 7/20; B29B 9/065; B29C 47/0004; B29C 47/0021; C08L 2203/162; C08L 2201/10; C08L 2205/025; C08J 2323/08; C08J 2423/06; B29K 2023/0625

(57) ABSTRACT

A polyethylene blend composition suitable for film applications comprising from 10 to 100 percent by weight of an ethylene-based polymer made by the process of: selecting an ethylene/α-olefin interpolymer (LLDPE) having a Comonomer Distribution Constant (CDC) in the range of from 75 to 300, a vinyl unsaturation of less than 150 vinyls per one million carbon atoms of the ethylene/α-olefin interpolymer; a zero shear viscosity ratio (ZSVR) in the range from 4 to 50; a density in the range of from 0.925 to 0.950 g/cm³, a melt index (I₂) in a range of from 0.1 to 2.5 g/10 minutes, a molecular weight distribution (M_{w}/Mₙ) in the range of from 1.8 to 4.0; reacting said ethylene/α-olefin interpolymer with an alkoxy amine derivative in an amount equal to or less than 900 parts derivative per million parts by weight of total ethylene/α-olefin interpolymer under conditions sufficient to increase the melt strength of the ethylene/α-olefin interpolymer is provided.

### FIELD OF INVENTION

The instant invention relates to a polyethylene blend composition and film made therefrom.

### BACKGROUND OF THE INVENTION

For collation shrink film and biaxially oriented polyethylene (BOPE) shrink film, a number of film properties are needed to obtain adequate package performance, including high shrink force/tension, good optics (low haze and high gloss), low elongation, and good dart/puncture performance. Currently structures typically utilize >50-60% low density polyethylene (LDPE) for the majority of these properties in either a monolayer or 3 layer structure. The addition of LDPE generally results in a reduction in especially toughness properties such as dart and puncture. Therefore, there remains a need for a polyethylene composition which provides these various properties.

### SUMMARY OF THE INVENTION

The instant invention provides a polyethylene blend composition and film made therefrom.

In one embodiment, the instant invention provides a polyethylene blend composition comprising from 10 to 100 percent by weight of an ethylene-based polymer made by the process of: selecting an ethylene/α-olefin interpolymer (LLDPE) having a Comonomer Distribution Constant (CDC) in the range of from 75 to 300, a vinyl unsaturation of less than 150 vinyls per one million carbon atoms of the ethylene/α-olefin interpolymer; a zero shear viscosity ratio (ZSVR) in the range from 4 to 50; a density in the range of from 0.925 to 0.950 g/cm³, a melt index (I₂) in a range of from 0.1 to 2.5 g/10 minutes, a molecular weight distribution (M_{w}/Mₙ) in the range of from 1.8 to 4.0; reacting said ethylene/α-olefin interpolymer with an alkoxy amine derivative in an amount equal to or less than 900 parts derivative per million parts by weight of total ethylene/α-olefin interpolymer under conditions sufficient to increase the melt strength of the ethylene/α-olefin interpolymer; and optionally from 5 to 90 percent by weight of a low density polyethylene composition; wherein when said polyethylene blend composition is formed into a film via a blown film process.

### BRIEF DESCRIPTION OF THE DRAWINGS

For the purpose of illustrating the invention, there is shown in the drawings a form that is exemplary; it being understood, however, that this invention is not limited to the precise arrangements and illustrations shown.

FIG. 1 is a graph illustrating the dynamical mechanical spectroscopy complex viscosity data at 190° C. versus frequency for Inventive Example 1 and Comparative Example 1;

FIG. 2 is a graph illustrating dynamical mechanical spectroscopy tan delta data at 190° C. versus frequency for Inventive Example 1 and Comparative Example 1;

FIG. 3 is a graph illustrating dynamical mechanical spectroscopy data of phase angle vs. complex modulus (Van-Gurp Palmen plot) at 190° C. for Inventive Example 1 and Comparative Example 1;

FIG. 4 is a graph illustrating melt strength data at 190° C. vs. velocity of Inventive Example 1 and Comparative Example 1;

FIG. 5 is a graph illustrating a Conventional GPC plot for Inventive Example 1 and Comparative Example 1;

FIG. 6 illustrates the CEF plot for Inventive Example 1 and Comparative Example 1; and

FIG. 7 illustrates the MW Ratio plot for Inventive Example 1 and Comparative Example 1.

### DETAILED DESCRIPTION OF THE INVENTION

The instant invention provides a polyethylene blend composition and film made therefrom.

The term “composition,” as used, includes a mixture of materials which comprise the composition, as well as reaction products and decomposition products formed from the materials of the composition.

The terms “blend” or “polymer blend,” as used herein, refers to an intimate physical mixture (that is, without reaction) of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be affected by physically mixing the two or more polymers on the macro level (for example, melt blending resins or compounding) or the micro level (for example, simultaneous forming within the same reactor).

The term “linear” as used herein refers to polymers where the polymer backbone of the polymer lacks measurable or demonstrable long chain branches, for example, the polymer can be substituted with an average of less than 0.01 long branches per 1000 carbons.

The term “polymer” as used herein refers to a polymeric compound prepared by polymerizing monomers, whether of the same or a different type. The generic term polymer thus embraces the term “homopolymer,” usually employed to refer to polymers prepared from only one type of monomer, and the term “interpolymer” as defined below. The terms “ethylene/α-olefin polymer” is indicative of interpolymers as described.

The term “interpolymer” as used herein, refers to polymers prepared by the polymerization of at least two different types of monomers. The generic term interpolymer includes copolymers, usually employed to refer to polymers prepared from two different monomers, and polymers prepared from more than two different types of monomers.

The term “ethylene-based polymer” refers to a polymer that contains more than 50 mole percent polymerized ethylene monomer (based on the total amount of polymerizable monomers) and, optionally, may contain at least one comonomer.

The term “ethylene/α-olefin interpolymer” refers to an interpolymer that contains more than 50 mole percent polymerized ethylene monomer (based on the total amount of polymerizable monomers) and at least one α-olefin.

In a first embodiment, the instant invention provides a polyethylene blend composition comprising from 10 to 100 percent by weight of an ethylene-based polymer made by the process of: selecting an ethylene/α-olefin interpolymer having a Comonomer Distribution Constant (CDC) in the range of from 75 to 300, a vinyl unsaturation of less than 150 vinyls per one million carbon atoms of the ethylene/α-olefin interpolymer; a zero shear viscosity ratio (ZSVR) in the range from 4 to 50; a density in the range of from 0.925 to 0.950 g/cm³, a melt index (I₂) in a range of from 0.1 to 2.5 g/10 minutes, a molecular weight distribution (M_{w}/Mₙ) in the range of from 1.8 to 4; reacting said ethylene/α-olefin interpolymer with an alkoxy amine derivative in an amount equal to or less than 900 parts derivative per million parts by weight of total ethylene/α-olefin interpolymer under conditions sufficient to increase the melt strength of the ethylene/α-olefin interpolymer; and optionally from 5 to 90 percent by weight of a low density polyethylene composition; wherein when said polyethylene blend composition is formed into a film.

The polyethylene blend composition comprises from 10 to 100 percent by weight of an ethylene-based polymer. All individual values and subranges from 10 to 100 percent by weight are included herein and disclosed herein; for example, the amount of ethylene-based polymer in the polyethylene blend composition may range from a lower limit of 10, 20, 30, 40, 50, 60, 70, 80 or 90 percent by weight to an upper limit of 15, 25, 35, 45, 55, 65, 75, 85, 95 or 100 percent by weight. For example, the amount of ethylene-based polymer can be from 10 to 100 percent by weight, or in the alternative, the amount of ethylene-based polymer can be from 10 to 60 percent by weight, or in the alternative, the amount of ethylene-based polymer can be from 60 to 100 percent by weight, or in the alternative, the amount of ethylene-based polymer can be from 20 to 80 percent by weight, or in the alternative, the amount of ethylene-based polymer can be from 30 to 50 percent by weight.

The ethylene-based polymer is produced by selecting an ethylene/α-olefin interpolymer having a Comonomer Distribution Constant (CDC) in the range of from 75 to 300, a vinyl unsaturation of less than 150 vinyls per one million carbon atoms of the ethylene/α-olefin interpolymer; a zero shear viscosity ratio (ZSVR) from 4 to 50; a density in the range of from 0.925 to 0.950 g/cm³, a melt index (I₂) in a range of from 0.1 to 2.5 g/10 minutes, a molecular weight distribution (M_{w}/Mₙ) in the range of from 1.8 to 4.

All individual values and subranges of CDC from 75 to 300 are included herein and disclosed herein; for example, the CDC of the ethylene/α-olefin interpolymer can be from a lower limit of 75, 125, 175, 225 or 275 to an upper limit of 100, 150, 200, 250 or 300. For example, the CDC of the ethylene/α-olefin interpolymer can be from 75 to 175, or in the alternative, the CDC of the ethylene/α-olefin interpolymer can be from 135 to 300, or in the alternative, the CDC of the ethylene/α-olefin interpolymer can be from 75 to 175, or in the alternative, the CDC of the ethylene/α-olefin interpolymer can be from 100 to 175, or in the alternative, the CDC of the ethylene/α-olefin interpolymer can be from 125 to 200.

All individual values and subranges of a vinyl unsaturation of less than 150 vinyls per one million carbon atoms of the ethylene/α-olefin interpolymer are included herein and disclosed herein; for example, the vinyl unsaturation can be from an upper limit of 150 vinyls per one million carbon atoms of the ethylene/α-olefin interpolymer, or in the alternative, the vinyl unsaturation can be from an upper limit of 125 vinyls per one million carbon atoms of the ethylene/α-olefin interpolymer, or in the alternative, the vinyl unsaturation can be from an upper limit of 100 vinyls per one million carbon atoms of the ethylene/α-olefin interpolymer, or in the alternative, the vinyl unsaturation can be from an upper limit of 50 vinyls per one million carbon atoms of the ethylene/α-olefin interpolymer.

All individual values and subranges of a zero shear viscosity ratio (ZSVR) from 4 to 50 are included herein and disclosed herein; for example, the ZSVR of the ethylene/α-olefin interpolymer can be from a lower limit of 4, 10, 16, 20, 26 or 29 to an upper limit of 5, 11, 17, 24, 28, 30, 35, 40, 45, or 50. For example, the ZSVR of the ethylene/α-olefin interpolymer can be from 4 to 50, or in the alternative, the ZSVR of the ethylene/α-olefin interpolymer can be from 4 to 30, or in the alternative, the ZSVR of the ethylene/α-olefin interpolymer can be from 16 to 30, or in the alternative, the ZSVR of the ethylene/α-olefin interpolymer can be from 8 to 30.

All individual values and subranges of a density from 0.925 to 0.950 g/cm³ are included herein and disclosed herein; for example, the density of the ethylene/α-olefin interpolymer can be from a lower limit of 0.925, 0.935, or 0.945 g/cm³ to an upper limit of 0.93, 0.94, or 0.950 g/cm³. For example, the density of the ethylene/α-olefin interpolymer can be from 0.925 to 0.950 g/cm³, or in the alternative, the density of the ethylene/α-olefin interpolymer can be from 0.930 to 0.950 g/cm³, or in the alternative, the density of the ethylene/α-olefin interpolymer can be from 0.925 to 0.94 g/cm³, or in the alternative, the density of the ethylene/α-olefin interpolymer can be from 0.93 to 0.945 g/cm³.

All individual values and subranges of a melt index (I₂) from 0.1 to 2.5 g/10 minutes are included herein and disclosed herein; for example, the melt index can be from a lower limit of 0.1, 0.2, 0.3, 0.5, 1, 1.5 or 2 g/10 minutes to an upper limit of 0.3, 0.5, 0.8, 1.3, 1.8, 2.3 or 2.5 g/10 minutes. For example, the melt index of the ethylene/α-olefin interpolymer can be from 0.1 to 2.5 g/10 minutes, or in the alternative, the melt index of the ethylene/α-olefin interpolymer can be from 0.1 to 1.25 g/10 minutes, or in the alternative, the melt index of the ethylene/α-olefin interpolymer can be from 1.25 to 2.5 g/10 minutes, or in the alternative, the melt index of the ethylene/α-olefin interpolymer can be from 0.5 to 2 g/10 minutes, or in the alternative, the melt index of the ethylene/α-olefin interpolymer can be from 1 to 2 g/10 minutes, or in the alternative, the melt index of the ethylene/α-olefin interpolymer can be from 0.8 to 1.5 g/10 minutes, or in the alternative, the melt index of the ethylene/α-olefin interpolymer can be from 0.6 to 1 g/10 minutes, or in the alternative, the melt index of the ethylene/α-olefin interpolymer can be from 0.1 to 0.5 g/10 minutes.

All individual values and subranges of a molecular weight distribution (M_{w}/Mₙ) from 1.8 to 4 are included herein and disclosed herein; for example, the molecular weight distribution of the ethylene/α-olefin interpolymer can be from a lower limit of 1.8, 2.4, 2.7, 3.0 or 3.6 to an upper limit of 2, 2.6, 3.2, 3.4, 3.8 or 4. For example, the molecular weight distribution of the ethylene/α-olefin interpolymer can be from 1.8 to 4, or in the alternative, the molecular weight distribution of the ethylene/α-olefin interpolymer can be from 1.8 to 2.5, or in the alternative, the molecular weight distribution of the ethylene/α-olefin interpolymer can be from 2.5 to 4, or in the alternative, the molecular weight distribution of the ethylene/α-olefin interpolymer can be from 2.2 to 3.4, or in the alternative, the molecular weight distribution of the ethylene/α-olefin interpolymer can be from 2 to 3.

The polymeric composition optionally comprises from 500 to 2000 ppm secondary antioxidant based on the total polymeric composition weight. Secondary antioxidants prevent formation of additional free radicals by decomposing the peroxide into thermally stable, non-radical, non-reactive products by means of an efficient alternative to thermolysis and generation of free radicals. Phosphites and thioesters are examples of functionalities operating as secondary antioxidants. All individual values and subranges from 500 to 2000 ppm are included herein and disclosed herein; for example, the amount of secondary antioxidant can be from a lower limit of 500, 700, 900, 1100, 1300, 1500, 1700 or 1900 ppm to an upper limit of 600, 800, 1000, 1200, 1400, 1600, 1800 or 2000 ppm. For example, when present, the secondary antioxidant may be present in an amount from 500 to 2000 ppm, or in the alternative, the secondary antioxidant may be present in an amount from 1250 to 2000 ppm, or in the alternative, the secondary antioxidant may be present in an amount from 500 to 1250 ppm, or in the alternative, the secondary antioxidant may be present in an amount from 750 to 1500 ppm. An example of a secondary antioxidant is IRGAFOS 168 or tris(2,4-ditert-butylphenyl)phosphite, which is commercially available from BASF.

In one embodiment, the secondary antioxidant is present in the polyethylene resin prior to mixing with the masterbatch. In an alternative embodiment, the secondary antioxidant is a component in the masterbatch.

The ethylene-based polymer is produced by reacting the ethylene/α-olefin interpolymer with an alkoxy amine derivative in an amount from greater than 0 to equal to or less than 900 parts alkoxy amine derivative per million (ppm) parts by weight of total ethylene/α-olefin interpolymer under conditions sufficient to increase the melt strength and/or increase the extensional viscosity of the ethylene/α-olefin interpolymer. All individual values and subranges from greater than 0 to 900 parts alkoxy amine derivative per million parts by weight of total ethylene/α-olefin interpolymer are included herein and disclosed herein. For example, the amount of alkoxy amine derivative can be from a lower limit of 0.5, 1, 15, 50, 100, 200, 300, 400, 500, 600, 700, or 800 ppm to an upper limit of 900, 850, 750, 650, 550, 450, 350, 250, 150, 60, 20 or 5 ppm. For example, the amount of the alkoxy amine derivative can be from greater than 0 to 900 ppm, or in the alternative, the amount of the alkoxy amine derivative can be from 1 to 900 ppm, or in the alternative, the amount of the alkoxy amine derivative can be from 15 to 600 ppm, or in the alternative, the amount of the alkoxy amine derivative can be from 25 to 400 ppm, or in the alternative, the amount of the alkoxy amine derivative can be from 30 to 200 ppm, or in the alternative, the amount of the alkoxy amine derivative can be from 15 to 70 ppm.

For purposes of the present invention “alkoxy amine derivatives” includes nitroxide derivatives. The alkoxy amine derivatives correspond to the formula:

(R₁)(R₂)N—O—R₃

where R₁ and R₂ are each independently of one another, hydrogen, C₄-C₄₂ alkyl or C₄-C₄₂ aryl or substituted hydrocarbon groups comprising O and/or N, and where R₁ and R₂ may form a ring structure together; and where R₃ is hydrogen, a hydrocarbon or a substituted hydrocarbon group comprising O and/or N. In particular aspects of the invention, groups for R₃ include —C₁-C₁₉ alkyl; —C₆-C₁₀ aryl; —C₂-C₁₉ akenyl; —O—C₁-C₁₉ alkyl; —O—C₆-C₁₀ aryl; —NH—C₁-C₁₉ alkyl; —NH—C₆-C₁₀ aryl; —N—(C₁-C₁₉ alkyl)₂. In a particular aspect of the invention, R₃ contains an acyl group. The alkoxy amine derivative may form nitroxylradical (R1)(R2)N—O* or amynilradical (R1)(R2)N* after decomposition or thermolysis.

A particularly preferred species of alkoxy amine derivative is 9-(acetyloxy)-3,8,10-triethyl-7,8,10-trimethyl-1,5-dioxa-9-azaspiro[5.5]u-ndec-3-yl]methyl octadecanoate which has the following chemical structure:

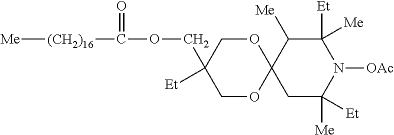

Examples of some preferred species for use in the present invention include the following:

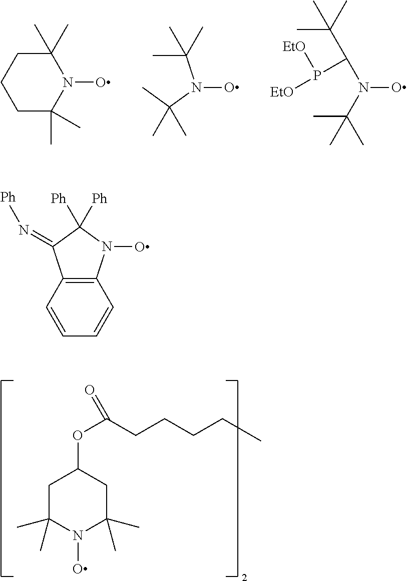

In general hydroxyl amine esters are more preferred with one particularly favored hydroxyl amine ester being 9-(acetyloxy)-3,8,10-triethyl-7,8,10-trimethyl-1,5-dioxa-9-azaspiro[5.5]u-ndec-3-yl]methyl octadecanoate.

Conditions sufficient to increase the melt strength of the ethylene/α-olefin interpolymer are described in detail in U.S. application Ser. No. 13/515,832, the disclosure of which is incorporated herein by reference.

The ethylene-based polymer has a melt strength from 2 to 20 cN. All individual values and subranges of a melt strength from 2 to 20 cN are included herein and disclosed herein; for example, the melt strength of the ethylene-based polymer can be from a lower limit of 2, 4, 6, 8, 10, 12, 14, 16, or 18 cN to an upper limit of 3, 5, 7, 9, 11, 13, 15, 17, 19 or 20 cN. For example, the melt strength of the ethylene-based polymer can be from 2 to 20 cN, or in the alternative, the melt strength of the ethylene-based polymer can be from 4 to 12 cN, or in the alternative, the melt strength of the ethylene-based polymer can be from 10 to 20 cN, or in the alternative, the melt strength of the ethylene-based polymer can be from 8 to 16 cN, or in the alternative, the melt strength of the ethylene-based polymer can be from 10 to 15 cN.

The polyethylene blend composition comprises optionally from 5 to 90 percent by weight of a low density polyethylene (LDPE) composition. All individual values and subranges from 5 to 90 percent by weight are included herein and disclosed herein; for example, when present, the LDPE can be present in an amount from a lower limit of 5, 20, 45, 60, 75 or 80 percent by weight to an upper limit of 10, 20, 40, 70 or 90 percent by weight. For example, the amount of LDPE in the polyethylene blend composition, when present, may be an amount from 5 to 90 percent by weight, or in the alternative, from 5 to 60 percent by weight, or in the alternative, from 50 to 90 percent by weight, or in the alternative, from 20 to 80 percent by weight, or in the alternative, from 30 to 70 percent by weight.

Low density polyethylene useful in the polyethylene blend composition may have a density in the range of from 0.910 g/cm³ to 0.940 g/cm³. All individual values and subranges from 0.910 g/cm³ to 0.940 g/cm³ are included herein and disclosed herein; for example, the LDPE can have a density from a lower limit of 0.910, 0.915, 0.92, 0.925, 0.93, or 0.935 g/cm³ to an upper limit of 0.913, 0.918, 0.923, 0.928, 0.933, 0.939, or 0.940 g/cm³. For example, the density of the LDPE can be from 0.910 g/cm³ to 0.940 g/cm³, or in the alternative, from 0.915 g/cm³ to 0.935 g/cm³, or in the alternative, from 0.91 g/cm³ to 0.925 g/cm³. The LDPE may have a melt index (I₂) from 0.1 to 5 g/10 minutes. All individual values and subranges from 0.1 to 5 g/10 minutes are included herein and disclosed herein; for example, the melt index of the LDPE can be from a lower limit of 0.1, 1, 2, 3, or 4 g/10 minutes to an upper limit of 0.5, 1.5, 2.5, 3.5, 4.5 or 5 g/10 minutes. For example, the melt index of the LDPE can be from 0.1 to 5 g/10 minutes, or in the alternative, the melt index of the LDPE can be from 0.2 to 2 g/10 minutes, or in the alternative, the melt index of the LDPE can be from 0.1 to 2.5 g/10 minutes, or in the alternative, the melt index of the LDPE can be from 2.4 to 5 g/10 minutes, or in the alternative, the melt index of the LDPE can be from 0.5 to 3 g/10 minutes.

In another embodiment, a film formed via a blown film process from the polyethylene blend composition and having a thickness of approximately 2 mil has an MD shrink tension of greater than 16 psi. All individual values and subranges of MD shrink tension of greater than 16 psi are included herein and disclosed herein; for example, the MD shrink tension can be from a lower limit of 16, 16.2, 16.4, 16.6, 16.8, or 17 psi. In one embodiment, the MD shrink tension has an upper limit of 50 psi. All individual values and subranges from less than or equal to 50 psi are included herein and disclosed herein; for example, the upper limit of the MD shrink tension can be 50, 40, 30, or 20 psi.

In another embodiment, a film formed via a blown film process from the polyethylene blend composition and having a thickness of approximately 2 mil has a CD shrink tension of greater than or equal to 1 psi. All individual values and subranges of CD shrink tension of greater than or equal to 1 psi are included herein and disclosed herein; for example, the CD shrink tension can be from a lower limit of 1, 1.005, 1.01, 1.015, 1.02, 1025 or 1.03 psi. In one embodiment, the CD shrink tension has an upper limit of 10 psi. All individual values and subranges from less than or equal to 10 psi are included herein and disclosed herein; for example, the upper limit of the CD shrink tension can be 10, 8, 6, 4, or 2 psi.

In yet another embodiment, the ethylene-based polymer is produced by reacting the ethylene/α-olefin interpolymer with from 10 ppm to 1000 ppm of at least one peroxide having a 1 hour half-life decomposition temperature from 160° C. to 250° C. under conditions sufficient to increase the melt strength and/or increase the extensional viscosity of the ethylene/α-olefin interpolymer. One example of such a peroxide is TRIGONOX 311, which is commercially available from AkzoNobel Polymer Chemicals LLC (Chicago, Ill., USA).

The polyethylene blend composition may be used for any appropriate end use. The inventive polyethylene blend composition may be employed in a variety of conventional thermoplastic fabrication processes to produce useful articles, including objects comprising at least one film layer, such as a monolayer film, or at least one layer in a multilayer film prepared by cast, blown, calendered, or extrusion coating processes; molded articles, such as blow molded, injection molded, or rotomolded articles; extrusions; fibers; and woven or non-woven fabrics.

The inventive polyethylene blend composition may further be blended with other natural or synthetic materials, polymers, additives, reinforcing agents, ignition resistant additives, antioxidants, stabilizers, colorants, extenders, crosslinkers, blowing agents, and plasticizers. Suitable polymers for blending with the inventive polyethylene blend composition are described in PCT Publication WO2011/159376, the entire disclosure of which is incorporated herein in by reference.

In another embodiment, the invention provides a film comprising the polyethylene blend composition according to any of the embodiments disclosed herein.

### EXAMPLES

The following examples illustrate the present invention but are not intended to limit the scope of the invention.

### Resin Production

All (co)monomer feeds (ethylene, 1-octene) and the process solvent (a narrow boiling range high-purity isoparaffinic solvent trademarked Isopar E and commercially available from Exxon Mobil Corporation) are purified with molecular sieves before introduction into the reaction environment. High purity hydrogen is supplied by cylinders and is ready for metering and delivery to the reactors and it is not further purified. The reactor monomer feed (ethylene) streams are pressurized via mechanical compressor to above reaction pressure at 725 psig. The solvent feeds are mechanically pressurized to above reaction pressure at 725 psig. The comonomer (1-octene) feed is also mechanically pressurized and injected directly into the feed stream for the second reactor. Three catalyst components are injected into the first reactor (CAT-A, RIBS-2, and MMAO-3A). Prior to injection in the reactor all of these catalyst components are batch diluted with Isopar E to an appropriate concentration to allow metering within the plant capability. The catalyst components to the second reactor are similarly delivered with three components fed to the second reactor (CAT-A, RIBS-2, and MMAO-3A). These catalyst components are also batch diluted with Isopar E to an appropriate concentration to allow metering within the plant capability. All catalyst components are independently mechanically pressurized to above reaction pressure at 725 psig. All reactor catalyst feed flows are measured with mass flow meters and independently controlled with positive displacement metering pumps.

The continuous solution polymerization reactors consist of two liquid full, non-adiabatic, isothermal, circulating, and independently controlled loops operating in a series configuration. Each reactor has independent control of all solvent, monomer, comonomer, hydrogen, and catalyst component feeds. The combined solvent, monomer, comonomer and hydrogen feed to each reactor is independently temperature controlled to anywhere between 10° C. to 50° C. and typically 50° C. for the first reactor and 30° C. for the second reactor by passing the feed stream through one or more heat exchangers. The fresh comonomer feed to the polymerization reactor is aligned to the second reactor. The total fresh feed to each polymerization reactor is injected into the reactor at two locations per reactor roughly with equal reactor volumes between each injection location. The fresh feed to both reactors is controlled typically with each injector receiving half of the total fresh feed mass flow. The polymerization reaction contents exiting the first reactor are injected into the second reactor near the lower pressure fresh feed. The catalyst components for the first reactor are injected into the polymerization reactor through specially designed injection stingers and are each injected into the same relative location in the first reactor. The catalyst components for the second reactor are injected into the second polymerization reactor through specially designed injection stingers and are each injected into the same relative location in the second reactor.

The primary catalyst component feed for each reactor (CAT-A) is computer controlled to maintain the individual reactor monomer concentration at a specified target. The cocatalyst components (RIBS-2 and MMAO-3A) are fed based on calculated specified molar ratios to the primary catalyst component. Immediately following each fresh injection location (either feed or catalyst), the feed streams are mixed with the circulating polymerization reactor contents with Kenics static mixing elements. The contents of each reactor are continuously circulated through heat exchangers responsible for removing much of the heat of reaction and with the temperature of the coolant side responsible for maintaining an isothermal reaction environment at the specified reactor temperature. Circulation around each reactor loop is provided by a screw pump. The effluent from the first polymerization reactor (containing solvent, monomer, comonomer, hydrogen, catalyst components, and dissolved polymer) exits the first reactor loop and passes through a control valve (responsible for controlling the pressure of the first reactor at a specified target) and is injected into the second polymerization reactor of similar design. After the combined polymerization stream exits the second reactor it is contacted with water to stop the reaction. The stream then goes through another set of Kenics static mixing elements to evenly disperse the water catalyst kill and any additives if used. No additives or antioxidants were added in this case.

The effluent (containing solvent, monomer, comonomer, hydrogen, catalyst components, and dissolved polymer) then passes through a heat exchanger to raise the stream temperature in preparation for separation of the polymer from the lower boiling reaction components. The stream then enters a two stage separation and devolatization system where the polymer is removed from the solvent, hydrogen, and non-reacted monomer and comonomer. The recycled stream is purified before entering the reactor again. The polymer stream then enters a die specially designed for underwater pelletization, is cut into uniform solid pellets, dried, and transferred into a hopper.

The non-polymer portions removed in the devolatilization step pass through various pieces of equipment which separate most of the monomer which is removed from the system and sent to a flare for destruction. Most of the solvent and comonomer are recycled back to the reactor after passing through purification beds. This solvent can still have non-reacted co-monomer in it that is fortified with fresh co-monomer prior to re-entry to the reactor as previously discussed. This fortification of the co-monomer is an essential part of the product density control method. This recycle solvent can contain some dissolved hydrogen which is then fortified with fresh hydrogen to achieve the polymer molecular weight target. A very small amount of solvent leaves the system where it is purged from the system.

Tables 1-4 summarize the conditions for polymerization for the starting ethylene/α-olefin interpolymer, or base resin. The untreated base resin is used as Comparative Example 1 and was subsequently treated to produce Inventive Example 1.

TABLE 1
Process reactor feeds used to make base resin.

| REACTOR FEEDS | CE 1 |
|---|---|
| Primary Reactor Feed Temperature (° C.) | 50 |
| Primary Reactor Total Solvent Flow (lb/hr) | 892 |
| Primary Reactor Fresh Ethylene Flow (lb/hr) | 170 |
| Primary Reactor Total Ethylene Flow (lb/hr) | 177 |
| Comonomer Type | 1-octene |
| Primary Reactor Fresh Comonomer Flow (lb/hr) | 0 |
| Primary Reactor Total Comonomer Flow (lb/hr) | 12.8 |
| Primary Reactor Fresh Hydrogen Flow (sccm) | 2,388 |
| Secondary Reactor Feed Temperature (° C.) | 30 |
| Secondary Reactor Total Solvent Flow (lb/hr) | 480 |
| Secondary Reactor Fresh Ethylene Flow (lb/hr) | 180 |
| Secondary Reactor Total Ethylene Flow (lb/hr) | 184 |
| Secondary Reactor Fresh Comonomer Flow (lb/hr) | 8.2 |
| Secondary Reactor Total Comonomer Flow (lb/hr) | 15 |
| Secondary Reactor Fresh Hydrogen Flow (sccm) | 10,152 |

TABLE 2
Process reaction conditions used to make base resin.

| REACTION | CE 1 |
|---|---|
| Primary Reactor Control Temperature (° C.) | 185 |
| Primary Reactor Pressure (Psig) | 725 |
| Primary Reactor Ethylene Conversion (wt %) | 78.2 |
| Primary Reactor FTnIR Outlet [C2] (g/L) | 21.4 |
| Primary Reactor Viscosity (cP) | 1,413 |
| Secondary Reactor Control Temperature (° C.) | 190 |
| Secondary Reactor Pressure (Psig) | 730 |
| Secondary Reactor Ethylene Conversion (wt %) | 89.9 |
| Secondary Reactor FTnIR Outlet [C2] (g/L) | 7.8 |
| Secondary Reactor Viscosity (cP) | 711 |
| Overall Ethylene conversion by vent (wt %) | 93.8 |

TABLE 3
Catalyst conditions used to make base resin.

| CATALYST | CE 1 |
|---|---|
| Primary Reactor: | |
| Catalyst Type | CAT-A |
| Co-Catalyst-1 Molar Ratio | 1.8 |
| Co-Catalyst-1 Type | RIBS-2 |
| Co-Catalyst-2 Molar Ratio | 4.9 |
| Co-Catalyst-2 Type | MMAO-3A |
| Secondary Reactor: | |
| Catalyst Type | CAT-A |
| Co-Catalyst-1 Molar Ratio | 1.2 |
| Co-Catalyst-1 Type | RIBS-2 |
| Co-Catalyst-2 Molar Ratio | 5 |
| Co-Catalyst-2 Type | MMAO-3A |

TABLE 4
Catalysts and catalyst components detailed nomenclature.

| Description | CAS Name |
|---|---|
| CAT-A | Zirconium, [2,2′″-[1,3-propanediylbis(oxy-κO)]bis[3″,5,5″- |
| | tris(1,1-dimethylethyl)-5′-methyl[1,1′:3′,1″-terphenyl]-2′- |
| | olato-κO]]dimethyl-, (OC-6-33)- |
| RIBS-2 | Amines, bis(hydrogenated tallow alkyl)methyl, |
| | tetrakis(pentafluorophenyl)borate(1-) |
| MMAO-3A | Aluminoxanes, iso-Bu Me, branched, cyclic and linear; |
| | modified methyl aluminoxane |

The base resin was modified as described below in order to produce the Inventive Examples.

### Production of Inventive Example 1

The production was described previously for the base resin for Inventive Example 1, Comparative Example 1. This resin was compounded by co-feeding it through a twin-screw extruder with a masterbatch comprising 5 wt % of Irgafos 168 in 1.64 wt % of the base resin for Inventive Example 1. The thus modified resin was further compounded using a masterbatch comprising 2.0 wt % of the total resin; this masterbatch comprised 2,500 ppm of CGX CR 946, an alkoxyamine derivative which is commercially available from BASF, in a low density polyethylene (LDPE) resin as the carrier (I₂ or MI of 2 and density of 0.918 g/cc). The final amount of Irgafos 168 in the resin was 803 ppm and the final amount of CGX CR 946 in the resin was 51 ppm. The amount of LDPE in the final resin was 2.0 wt %.

### Extrusion Conditions for Production of Inventive Example 1

The twin-screw extruder is a co-rotating, intermeshing, 40 mm twin screw Century ZSK-40 extruder equipped with a 150 Hp drive, 244 Armature amps (at maximum) and operating at 1200 screw rpm (at maximum). The length-to-diameter ratio is 37.13. The screw is 1485 mm in length design comprising 24 conveying and 3 kneading elements. There is a nitrogen purge at the throat of the extruder and there are two feeders, one feeding the resin and the other the antioxidant-containing masterbatch. There are 9 barrels, the first three having temperatures set to 25° C. and the rest set to 220° C. The extruder operates at 175 rpm.

A melt pump is attached to the twin-screw extruder on one end and to a single-screw extruder on the other. The melt pump is a Maag 100 CC/revolution pump that helps to convey the molten polymer from the extruder and out of the remaining downstream equipment. It is powered by a 15 hp motor with a 20.55/1 reduction gear. The pump is equipped with a pressure transducer on the suction and discharge spool pieces, and a 5,200 psi rupture disc on the outlet transition piece. There are heater zones on the melt pump and the inlet and outlet transition pieces, set to 220° C. The masterbatch containing CGX CR 946 is injected to the resin using a Sterling 2½ Inch single-screw extruder equipped with a rupture disc of 4,000 psig. The single-screw extruder operates at 50 rpm with 4 heated zone temperatures set to 223 to 224° C.

Downstream of the melt pump is a static mixer, comprising 18 twisted-tape Kenics static mixer elements having 52 inches in total length. There are seven heater zones on the static mixer ranging from 218 to 234° C., depending on the time of the experiment. The static mixer is attached to an underwater Gala pelletizer equipped with a 12 hole (2.36 mm hole diameter) die. The cutter has a four-blade hub.

### Inventive Ethylene-Based Polymer Compositions (Inventive Example 1):

Inventive ethylene-based polymer composition, i.e. Inventive Examples 1, was prepared according to the above procedure. The process conditions used to report the resin used for modification into Inventive Example 1 are reported in Table 1-4.

Comparative Example 1 is an ethylene/1-octene polyethylene produced as described under conditions reported in Tables 1-4 with an I₂ of approximately 0.5 g/10 minutes and a density of 0.935 g/cm³.

Characterization properties of the Inventive Example 1 and Comparative Example 1 are reported in Table 5-15.

The melt index, melt index ratio, and density are reported in Table 5. Inventive Example 1 has a lower melt index (I₂), and higher I₁₀/I₂ than the comparative example. The lower melt index is advantageous in terms of higher shrink properties as is the higher I₁₀/I₂. The density of all samples is relatively high as is desired for high modulus shrink films.

DSC data are reported in Table 6. The melting temperatures, percent crystallinities, and crystallization temperatures for the Comparative Example are within the range of these properties shown for the Inventive Example.

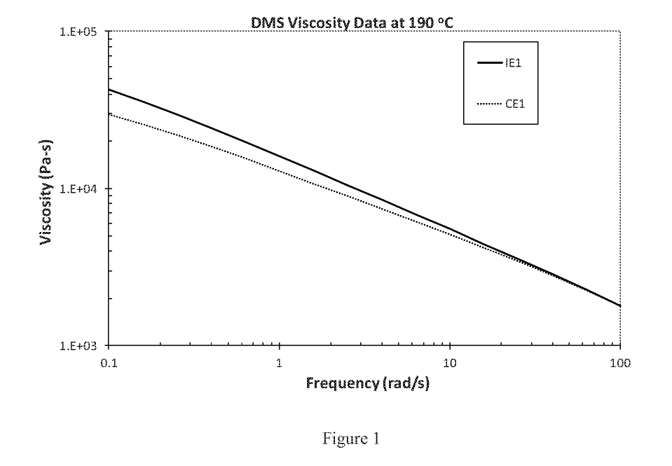

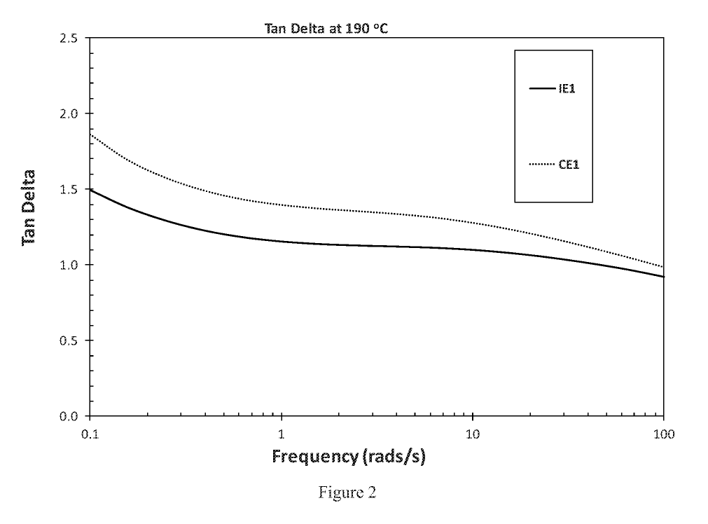

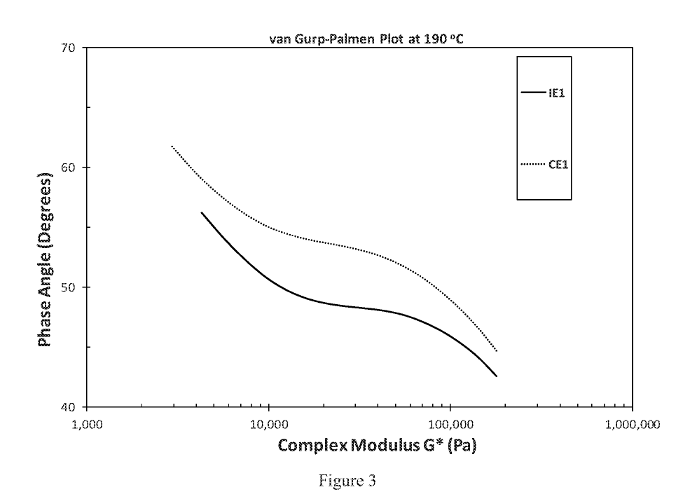

DMS viscosity, tan delta, and complex modulus versus phase angle data are given in Tables 7-9, respectively, and plotted in FIGS. 1-3, respectively. The viscosity data of Table 7 and FIG. 1 as well as the viscosity at 0.1 rad/s over that at 100 rad/s in Table 7 show that the Inventive Example shows high shear thinning behavior of viscosity decreasing rapidly with increasing frequency as compared to the Comparative Example. From Table 8 and FIG. 2, the Inventive Example has low tan delta values or high elasticity as compared to the Comparative Example, especially at low frequencies such as 0.1 rad/s. Table 9 and FIG. 3 show a form of the DMS data which is not influenced as greatly by the overall melt index (MI or I₂) or molecular weight. The more elastic materials are lower on this plot (i.e., lower phase angle for a given complex modulus); the Inventive Example is lower on this plot or more elastic than the Comparative Example.

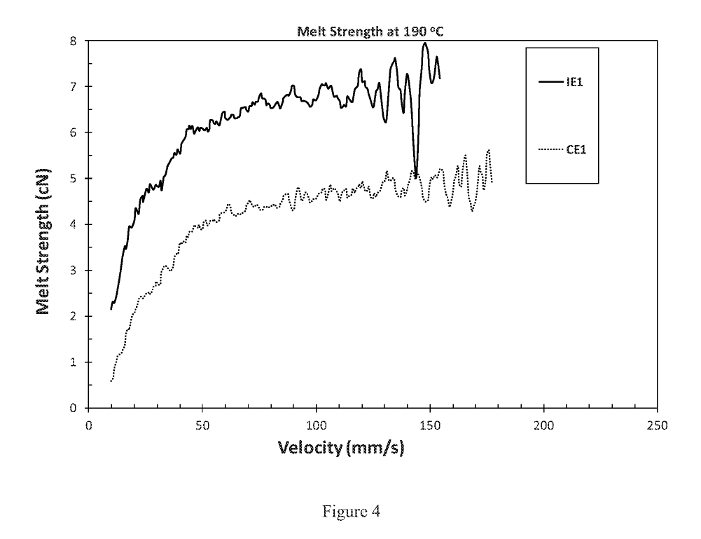

Melt strength data is shown in Table 10 and plotted in FIG. 4. The melt strengths are influenced by the melt index with the melt strength in general being higher for lower melt index materials. Additionally, more highly branched or modified materials are expected to have higher melt strengths. Inventive Example 1 has a high melt strength value, relatively, as compared to the Comparative Example.

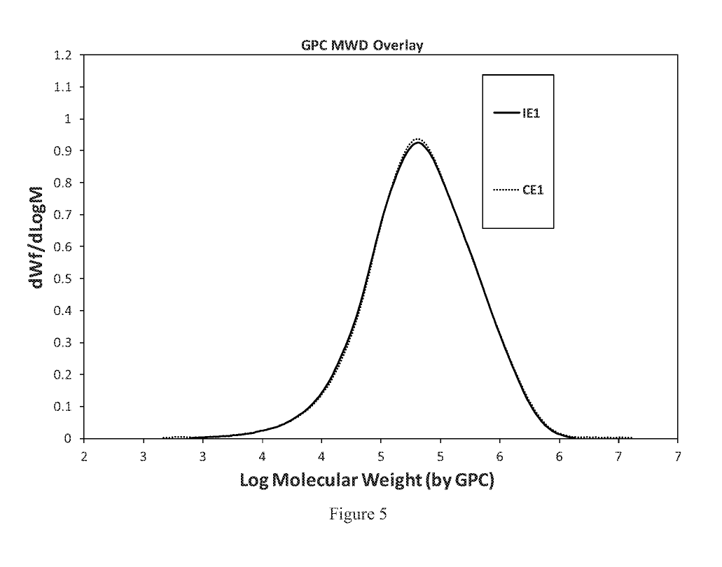

GPC data for the Inventive Example and Comparative Example are shown in Table 11 and FIG. 5. In general, the Inventive Example has a narrow M_{w}/Mₙ of less than 4.0.

Zero shear viscosity (ZSV) data for the Inventive Example and Comparative Example are shown in Table 12. The Inventive Example has a high ZSV ratio (ZSVR) as compared to the Comparative Example.

Unsaturation data for the Inventive Example and Comparative Example are shown in Table 13. The Inventive Example has very low total unsaturation values.

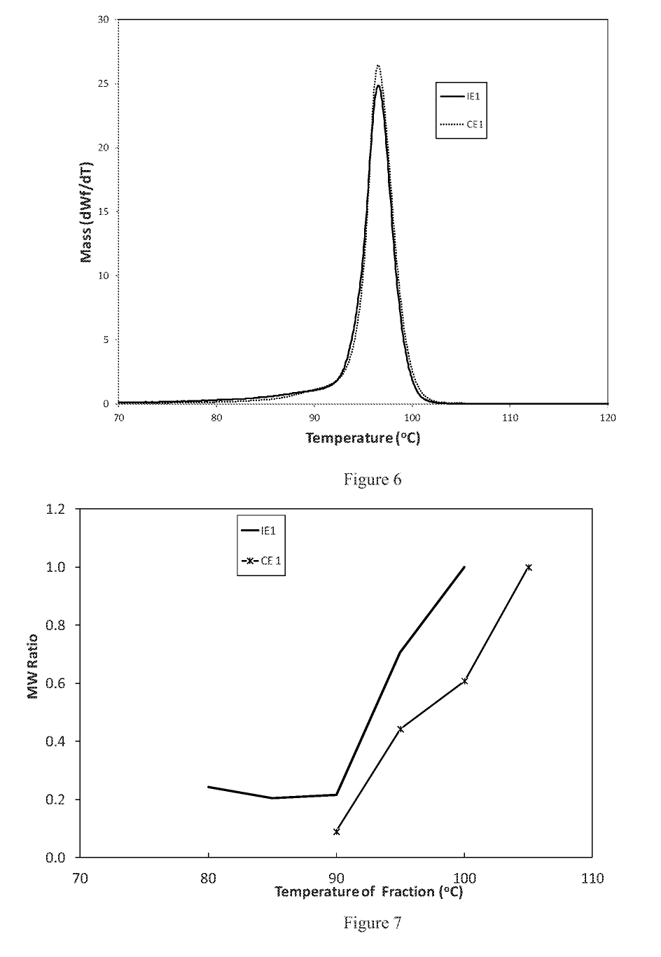

Short chain branching distribution data are shown in Table 14 and FIG. 6. The Inventive Example has a higher CDC. The Inventive Example has a monomodal or bimodal distribution excluding the soluble fraction at temperature ˜30° C.

The MW Ratio is measured by cross fractionation (TREF followed by GPC) for the Inventive Example and Comparative Example. The MW Ratio is shown in Tables 15 and FIG. 7. The Inventive Example has a MW Ratio values increasing from a low value (close to 0.24) with temperature, and reaching a maximum value of 1.00 at the highest temperature. The Inventive Example has a cumulative weight fraction less than 0.10 for the temperature fractions up to 50° C. At temperatures from 80° C. to 100° C., the MW Ratio of the Inventive Example is higher than that of the Comparative Example.

### Films

Monolayer films are made in a composition of 70 wt % linear low density polyethylene (LLDPE) (IE 1 and CE 1 of Table 5) and 30 wt % LDPE in which the LDPE used is a high pressure low density polyethylene made by The Dow Chemical Company (LDPE 1321, 0.25 MI, 0.921 g/cm³).

Each formulation was compounded on a MAGUIRE gravimetric blender. A polymer processing aid (PPA), DYNAMAR FX-5920A, was added to each formulation. The PPA was added at 1 wt % of masterbatch, based on the total weight of the weight of the formulation. The PPA masterbatch (Ingenia AC-01-01, available from Ingenia Polymers) contained 8 wt % of DYNAMAR FX-5920A in a polyethylene carrier. This amounts to 800 ppm PPA in the polymer.

The monolayer blown films were made on an “8 inch die” with a polyethylene “Davis Standard Barrier II screw.” External cooling by an air ring and internal bubble cooling were used. General blown film parameters, used to produce each blown film, are shown in Table 16. The temperatures are the temperatures closest to the pellet hopper (Barrel 1), and in increasing order, as the polymer was extruded through the die. The films were run at 250 lb/hr. The films are tested for their various properties according to the test methods described below, and these properties are reported in Table 17.

Inventive Film 1 showed good MD and CD shrink tension and free shrink, which is advantageous for use in shrink film, comparable optics (haze, gloss, clarity), and generally good film properties (puncture and dart) when compared to the Comparative Film.

TABLE 5
I₂, I₁₀/I₂, and Density

| | I₂ (g/10 min) | I₁₀/I₂ | Density (g/cm³) |
|---|---|---|---|
| IE1 | 0.32 | 14.0 | 0.9331 |
| CE1 | 0.51 | 11.3 | 0.9342 |

TABLE 6
DSC data

| | Tₘ₁ (° C.) | Heat of Fusion (J/g) | % Cryst. | T_{c1} (° C.) |
|---|---|---|---|---|
| IE1 | 125.1 | 175.5 | 60.1 | 113.4 |
| CE1 | 125.0 | 176.4 | 60.4 | 111.5 |

TABLE 7
DMS viscosity data

| | IE1 | CE1 |
|---|---|---|
| Frequency (rad/s) | Viscosity (Pa-s) | Viscosity (Pa-s) |
| 0.1 | 42,579 | 29,502 |
| 0.16 | 35,912 | 25,698 |
| 0.25 | 29,782 | 21,954 |
| 0.40 | 24,383 | 18,530 |
| 0.63 | 19,823 | 15,482 |
| 1.00 | 16,029 | 12,891 |
| 1.58 | 12,984 | 10,746 |
| 2.51 | 10,476 | 8,923 |
| 3.98 | 8,470 | 7,414 |
| 6.31 | 6,848 | 6,162 |
| 10.00 | 5,536 | 5,106 |
| 15.85 | 4,436 | 4,213 |
| 25.12 | 3,570 | 3,432 |
| 39.81 | 2,856 | 2,792 |
| 63.10 | 2,268 | 2,249 |
| 100.00 | 1,790 | 1,797 |
| Viscosity 0.1/100 | 23.8 | 16.4 |

TABLE 8
DMS tan delta data

| Frequency | IE1 | CE1 |
|---|---|---|
| (rad/s) | Tan Delta | Tan Delta |
| 0.1 | 1.49 | 1.86 |
| 0.16 | 1.38 | 1.69 |
| 0.25 | 1.29 | 1.57 |
| 0.40 | 1.23 | 1.49 |
| 0.63 | 1.18 | 1.43 |
| 1.00 | 1.15 | 1.40 |
| 1.58 | 1.14 | 1.37 |
| 2.51 | 1.13 | 1.36 |
| 3.98 | 1.12 | 1.34 |
| 6.31 | 1.11 | 1.31 |
| 10.00 | 1.10 | 1.28 |
| 15.85 | 1.08 | 1.23 |
| 25.12 | 1.05 | 1.18 |
| 39.81 | 1.01 | 1.12 |
| 63.10 | 0.97 | 1.06 |
| 100.00 | 0.92 | 0.99 |

TABLE 9
DMS G* and phase angle data

| | IE1 | | | |
|---|---|---|---|---|
| | | Phase | CE1 | |
| Frequency | | Angle | | Phase Angle |
| (rad/s) | G* (Pa) | (Degrees) | G* (Pa) | (Degrees) |
| 0.1 | 4,258 | 56.21 | 2,950 | 61.75 |
| 0.16 | 5,692 | 54.02 | 4,073 | 59.38 |
| 0.25 | 7,481 | 52.23 | 5,515 | 57.56 |
| 0.40 | 9,707 | 50.79 | 7,377 | 56.14 |
| 0.63 | 12,507 | 49.77 | 9,768 | 55.09 |
| 1.00 | 16,029 | 49.09 | 12,891 | 54.40 |
| 1.58 | 20,579 | 48.67 | 17,032 | 53.93 |
| 2.51 | 26,314 | 48.42 | 22,414 | 53.59 |
| 3.98 | 33,719 | 48.25 | 29,515 | 53.22 |
| 6.31 | 43,210 | 48.04 | 38,880 | 52.72 |
| 10.00 | 55,360 | 47.69 | 51,061 | 51.98 |
| 15.85 | 70,308 | 47.12 | 66,777 | 50.99 |
| 25.12 | 89,664 | 46.34 | 86,216 | 49.74 |
| 39.81 | 114,000 | 45.34 | 111,000 | 48.25 |
| 63.10 | 143,000 | 44.13 | 142,000 | 46.55 |
| 100.00 | 179,000 | 42.60 | 180,000 | 44.62 |

TABLE 10
Melt strength

| | Melt Strength (cN) |
|---|---|
| IE1 | 6.9 |
| CE1 | 5.0 |

TABLE 11
GPC data by conventional GPC

| | M_{w} (g/mol) | Mₙ (g/mol) | M_{w}/Mₙ | M_{z} (g/mol) |
|---|---|---|---|---|
| IE1 | 108,748 | 36,187 | 3.01 | 243,658 |
| CE1 | 113,634 | 36,380 | 3.12 | 294,508 |

TABLE 12
Weight average molecular weight Mw from conventional GPC, Zero shear
viscosity ZSV, and ZSV Ratio.

| | M_{w} | | Log (M_{w} in | Log (ZSV | ZSV |
|---|---|---|---|---|---|
| | (g/mol) | ZSV (Pa-s) | g/mol) | in Pa-s) | Ratio |
| IE 1 | 108,748 | 108,401 | 5.036 | 5.035 | 19.60 |
| CE 1 | 113,634 | 49,300 | 5.056 | 4.693 | 7.59 |

TABLE 13
Unsaturations
Unsaturation Unit/1,000,000 C

| | | | | | Total |
|---|---|---|---|---|---|
| | Vinylene | Trisubstituted | Vinyl | Vinylidene | Unsaturations |
| IE 1 | 8 | 1 | 49 | 5 | 63 |
| CE 1 | 13 | 4 | 57 | 3 | 77 |

TABLE 14
CEF

| | Comonomer | Comonomer | Half | | |
|---|---|---|---|---|---|
| | Distribution | Distribution Index | Width | Halfwidth | |
| | Index | Stdev (° C.) | (° C.) | StDev | CDC |
| IE1 | 0.784 | 5.912 | 2.856 | 0.483 | 162.2 |
| CE1 | 0.796 | 3.634 | 2.710 | 0.746 | 106.7 |

TABLE 15
MW Ratio

| | | Fraction | | | | | | | | | | | | | | | |
|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 |
| | | Temp, ° C. | | | | | | | | | | | | | | | |
| | | 30 | 35 | 40 | 45 | 50 | 55 | 60 | 65 | 70 | 75 | 80 | 85 | 90 | 95 | 100 | 105 |
| IE1 | Wt % | 0.9 | 0.1 | 0 | 0 | 0 | 0 | 0.2 | 0.3 | 0.4 | 0.7 | 1.1 | 2 | 3.9 | 47.1 | 42.8 | 0.6 |
| | (Temp) | | | | | | | | | | | | | | | | |
| | Cumulative | 0.01 | 0.01 | 0.01 | 0.01 | 0.01 | 0.01 | 0.01 | 0.01 | 0.02 | 0.03 | 0.04 | 0.06 | 0.10 | 0.57 | 0.99 | 1.00 |
| | weight | | | | | | | | | | | | | | | | |
| | fraction | | | | | | | | | | | | | | | | |
| | MW Ratio | | | | | | | | | | | 0.24 | 0.21 | 0.22 | 0.71 | 1.00 | |
| CE1 | Wt % | 0.1 | 0 | 0 | 0 | 0 | 0 | 0 | 0 | 0.1 | 0.2 | 0.3 | 0.9 | 2.7 | 18.3 | 75.3 | 2.1 |
| | (Temp) | | | | | | | | | | | | | | | | |
| | Cumulative | 0.00 | 0.00 | 0.00 | 0.00 | 0.00 | 0.00 | 0.00 | 0.00 | 0.00 | 0.00 | 0.01 | 0.02 | 0.04 | 0.23 | 0.98 | 1.00 |
| | weight | | | | | | | | | | | | | | | | |
| | fraction | | | | | | | | | | | | | | | | |
| | MW Ratio | | | | | | | | | | | | | 0.09 | 0.44 | 0.61 | 1.00 |

TABLE 16
Blown film process parameters used to produce films.

| | |
|---|---|
| Blow up ratio (BUR) | 2.5 |
| Nominal Film thickness | 2.0 |
| Die gap (mil) | 70 |
| Air temperature (° F.) | 45 |

Temperature profile (° F.)

| | |
|---|---|
| Barrel 1 | 350 |
| Barrel 2 | 425 |
| Barrel 3 | 380 |
| Barrel 4 | 325 |
| Barrel 5 | 325 |
| Screen Temperature | 430 |
| Adapter | 430 |
| Block | 430 |
| Lower Die | 440 |
| Inner Die | 440 |
| Upper Die | 440 |

TABLE 17
Blown Film properties

| | Example | |
|---|---|---|
| | Comparative Film 1 | Inventive Film 1 |
| Film Thickness (mil) | 1.86 | 1.96 |
| Total Haze (%) | 15.4 | 16.1 |
| Internal Haze (%) | 4.0 | 3.3 |
| 45° Gloss (%) | 43.6 | 41.7 |
| Clarity (%) | 95.0 | 94.6 |
| MD Shrink Tension (psi) | 15.17 | 17.70 |
| CD Shrink Tension (psi) | 0.97 | 1.03 |
| MD Free Shrinkage (%) 150° C. | 78.8 | 79.8 |
| CD Free Shrinkage (%) 150° C. | 15.9 | 18.3 |
| Puncture (ft-lbf/in³) | 76 | 91 |
| Dart Drop Impact A (g) | 93 | 103 |
| MD Tear (g) | 72 | 75 |
| CD Tear (g) | 787 | 672 |
| MD Tear (g/mil) Normalized | 39 | 40 |
| CD Tear (g/mil) Normalized | 416 | 350 |
| 2% MD Secant Modulus (psi) | 55,490 | 53,510 |
| 2% CD Secant Modulus (psi) | 68,497 | 66,334 |
| MD Break Stress (psi) | 5,612 | 5,032 |
| CD Break Stress (psi) | 4,542 | 4,791 |
| MD Strain at Break (%) | 564 | 477 |
| CD Strain at Break (%) | 723 | 746 |
| MD Stress at Yield (psi) | 3,200 | 3,446 |
| CD Stress at Yield (psi) | 2,748 | 2,710 |
| MD Strain at Yield (%) | 96.1 | 101.5 |
| CD Strain at Yield (%) | 9.7 | 9.4 |

### Test Methods

Test methods include the following:

### Melt Index

Melt index, or I₂ or MI, is measured in accordance with ASTM D 1238-10, Condition 190° C./2.16 kg, and is reported in grams eluted per 10 minutes. The I₁₀ is measured in accordance with ASTM D 1238, Condition 190° C./10 kg, and is reported in grams eluted per 10 minutes.

### Density

Samples for density measurements are prepared according to ASTM D 4703-10. Samples are pressed at 374° F. (190° C.) for five minutes at 10,000 psi (68 MPa). The temperature is maintained at 374° F. (190° C.) for the above five minutes, and then the pressure is increased to 30,000 psi (207 MPa) for three minutes. This is followed by a one minute hold at 70° F. (21° C.) and 30,000 psi (207 MPa). Measurements are made within one hour of sample pressing using ASTM D792-08, Method B.

### DSC Crystallinity

Differential Scanning calorimetry (DSC) can be used to measure the melting and crystallization behavior of a polymer over a wide range of temperature. For example, the TA Instruments Q1000 DSC, equipped with an RCS (refrigerated cooling system) and an autosampler is used to perform this analysis. During testing, a nitrogen purge gas flow of 50 ml/min is used. Each sample is melt pressed into a thin film at about 175° C.; the melted sample is then air-cooled to room temperature (˜25° C.). A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C. and held isothermal for 3 minutes in order to remove its thermal history. Next, the sample is cooled to −40° C. at a 10° C./minute cooling rate and held isothermal at −40° C. for 3 minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are peak melting temperature (Tm), peak crystallization temperature (Tc), heat of fusion (Hf) (in Joules per gram), and the calculated % crystallinity for polyethylene samples using Equation 1, shown below:

% Crystallinity=((H_{f})/(292J/g))×100 Equation 1

The heat of fusion (H_{f}) and the peak melting temperature are reported from the second heat curve. Peak crystallization temperature is determined from the cooling curve.

### Dynamic Mechanical Spectroscopy (DMS) Frequency Sweep

Melt rheology, a constant temperature frequency sweep, was performed using a TA Instruments Advanced Rheometric Expansion System (ARES) rheometer equipped with 25 mm parallel plates under a nitrogen purge. Frequency sweeps were performed at 190° C. for all samples at a gap of 2.0 mm and at a constant strain of 10%. The frequency interval was from 0.1 to 100 radians/second. The stress response was analyzed in terms of amplitude and phase, from which the storage modulus (G′), loss modulus (G″), and dynamic melt viscosity (η*) were calculated. The methods described in van Gurp and Palmen, Rheology Bulletin (1998) 67:5-8; Trinkle, S. and C. Friedrich, Rheologica Acta, 2001. 40(4); p. 322-328, were used to prepare the data presented in FIG. 3 (Van-Gurp Palmen plot).

### CEF Method

Comonomer distribution analysis is performed with Crystallization Elution Fractionation (CEF) (PolymerChar in Spain) (B. Monrabal et al, Macromol. Symp. 257, 71-79 (2007)). Ortho-dichlorobenzene (ODCB) with 300 ppm antioxidant butylated hydroxytoluene (BHT) is used as the solvent. Sample preparation is done with autosampler at 160° C. for 2 hours under shaking at 4 mg/ml (unless otherwise specified). The injection volume is 300 μl. The temperature profile of the CEF is: crystallization at 3° C./min from 110° C. to 30° C., thermal equilibrium at 30° C. for 5 minutes, soluble fraction (SF) time at 2 minutes, elution at 3° C./min from 30° C. to 140° C. The flow rate during crystallization is at 0.052 ml/min. The flow rate during elution is at 0.50 ml/min. The data is collected at one data point/second.

The CEF column is packed by the Dow Chemical Company with glass beads at 125 um±6% (MO-SCI Specialty Products) with ⅛ inch stainless tubing. Glass beads are acid washed by MO-SCI Specialty with the request from the Dow Chemical Company. Column volume is 2.06 ml. Column temperature calibration is performed by using a mixture of NIST Standard Reference Material Linear polyethylene 1475a (1.0 mg/ml) and Eicosane (2 mg/ml) in ODCB. The temperature is calibrated by adjusting the elution heating rate so that NIST linear polyethylene 1475a has a peak temperature at 101.0° C., and Eicosane has a peak temperature of 30.0° C. The CEF column resolution is calculated with a mixture of NIST linear polyethylene 1475a (1.0 mg/ml) and hexacontane (Fluka, purum, ≧97.0%, 1 mg/ml). A baseline separation of hexacontane and NIST polyethylene 1475a is achieved. The area of hexacontane (from 35.0 to 67.0° C.) to the area of NIST 1475a from 67.0 to 110.0° C. is 50 to 50, the amount of soluble fraction below 35.0° C. is <1.8 wt %. The CEF column resolution is defined in Equation 2, as below, where the column resolution is 6.0:

$$Resolution = \frac{\begin{matrix}Peak Temperature of NIST 1475 a - \\ Peak Temperature of Hexacontane\end{matrix}}{\begin{matrix}Half \text{-} height Width of NIST 1475 a + \\ Half \text{-} height Width of Hexacontane\end{matrix}} \qquad Equation 2$$

### CDC Method

Comonomer distribution constant (CDC) is calculated from comonomer distribution profile by CEF. CDC is defined as Comonomer Distribution Index divided by Comonomer Distribution Shape Factor multiplying by 100 as shown in Equation 3, shown below:

$$CDC = \frac{Comonomer Distribution Index}{Comonomer Distribution Shape Factor} = \frac{Comonomer Distribution Index}{Half Width \text{/} Stdev} * 100 \qquad Equation 3$$

Comonomer distribution index stands for the total weight fraction of polymer chains with the comonomer content ranging from 0.5 of median comonomer content (C_{median}) and 1.5 of C_{median} from 35.0 to 119.0° C. Comonomer Distribution Shape Factor is defined as a ratio of the half width of comonomer distribution profile divided by the standard deviation of comonomer distribution profile from the peak temperature (Tₚ).

CDC is calculated from comonomer distribution profile by CEF, and CDC is defined as Comonomer Distribution Index divided by Comonomer Distribution Shape Factor multiplying by 100 as shown in Equation 3 and wherein Comonomer Distribution Index stands for the total weight fraction of polymer chains with the comonomer content ranging from 0.5 of median comonomer content (C_{median}) and 1.5 of C_{median} from 35.0 to 119.0° C., and wherein Comonomer Distribution Shape Factor is defined as a ratio of the half width of comonomer distribution profile divided by the standard deviation of comonomer distribution profile from the peak temperature (Tp).

CDC is calculated according to the following steps:

(A) Obtain a weight fraction at each temperature (T) (w_{T}(T)) from 35.0° C. to 119.0° C. with a temperature step increase of 0.200° C. from CEF according to Equation 4, as shown below;

$${\int }_{35}^{119.0} {w}_{T} ( T ) dT = 1 \qquad Equation 4$$

(B) Calculate the median temperature (T_{median}) at cumulative weight fraction of 0.500, according to Equation 5, as shown below;

$${\int }_{35}^{{T}_{median}} {w}_{T} ( T ) dT = 0.5 \qquad Equation 5$$

(C) Calculate the corresponding median comonomer content in mole % (C_{median}) at the median temperature (T_{median}) by using comonomer content calibration curve according to Equation 6, as shown below;

$$\begin{matrix}ln ( 1 - comonomercontent ) = - \frac{207.26}{273.12 + T} + 0.5533 & Equation 6 \\ {R}^{2} = 0.997 & \end{matrix}$$

(D) Construct a comonomer content calibration curve by using a series of reference materials with known amount of comonomer content, i.e., eleven reference materials with narrow comonomer distribution (mono-modal comonomer distribution in CEF from 35.0 to 119.0° C.) with weight average Mw of 35,000 to 115,000 (measured via conventional GPC) at a comonomer content ranging from 0.0 mole % to 7.0 mole % are analyzed with CEF at the same experimental conditions specified in CEF experimental sections;

(E) Calculate comonomer content calibration by using the peak temperature (Tp) of each reference material and its comonomer content; The calibration is calculated from each reference material as shown in Equation 6, wherein: R² is the correlation constant;

(F) Calculate Comonomer Distribution Index from the total weight fraction with a comonomer content ranging from 0.5*C_{median} to 1.5*C_{median}, and if T_{median} is higher than 98.0° C., Comonomer Distribution Index is defined as 0.95;

(G) Obtain Maximum peak height from CEF comonomer distribution profile by searching each data point for the highest peak from 35.0° C. to 119.0° C. (if the two peaks are identical, then the lower temperature peak is selected); half width is defined as the temperature difference between the front temperature and the rear temperature at the half of the maximum peak height, the front temperature at the half of the maximum peak is searched forward from 35.0° C., while the rear temperature at the half of the maximum peak is searched backward from 119.0° C., in the case of a well defined bimodal distribution where the difference in the peak temperatures is equal to or greater than the 1.1 times of the sum of half width of each peak, the half width of the inventive ethylene-based polymer composition is calculated as the arithmetic average of the half width of each peak; (H) Calculate the standard deviation of temperature (Stdev) according to Equation 7, as shown below:

$$Stdev = \sqrt{{\sum }_{35.0}^{119.0} {( T - {T}_{p} )}^{2} * {w}_{T} ( T )} \qquad Equation 7$$

### Conventional GPC M_{w-gpc} Determination

To obtain Mw-gpc values, the chromatographic system consist of either a Polymer Laboratories Model PL-210 or a Polymer Laboratories Model PL-220 equipped with a refractive index (RI) concentration detector. The column and carousel compartments are operated at 140° C. Three Polymer Laboratories 10-μm Mixed-B columns are used with a solvent of 1,2,4-trichlorobenzene. The samples are prepared at a concentration of 0.1 g of polymer in 50 mL of solvent. The solvent used to prepare the samples contain 200 ppm of the antioxidant butylated hydroxytoluene (BHT). Samples are prepared by agitating lightly for 4 hours at 160° C. The injection volume used is 100 microliters and the flow rate is 1.0 mL/min. Calibration of the GPC column set is performed with twenty one narrow molecular weight distribution polystyrene standards purchased from Polymer Laboratories. The polystyrene standard peak molecular weights are converted to polyethylene molecular weights shown in the Equation 8, as shown below where M is the molecular weight, A has a value of 0.4316 and B is equal to 1.0:

M_{polyethylene}=A(M_{polystyrene})^{B} Equation 8.

A third order polynomial is determined to build the logarithmic molecular weight calibration as a function of elution volume. The weight-average molecular weight by the above conventional calibration is defined as Mw_{cc} in Equation 9 as shown below:

$${M}_{w} ( cc ) = \frac{{\sum }_{i} {RI}_{i} * {M}_{cc , i}}{{\sum }_{i} {RI}_{i}} \qquad Equation 9$$

where, the summation is across the GPC elution curve, with R₁ and M_{cc} represents the RI detector signal and conventional calibration molecular weight at each GPC elution slice. Polyethylene equivalent molecular weight calculations are performed using PolymerChar Data Processing Software (GPC One). The precision of the weight-average molecular weight ΔMw is excellent at <2.6%.

### Creep Zero Shear Viscosity Measurement Method:

Zero-shear viscosities are obtained via creep tests that were conducted on an AR-G2 stress controlled rheometer (TA Instruments; New Castle, Del.) using 25-mm-diameter parallel plates at 190° C. The rheometer oven is set to test temperature for at least 30 minutes prior to zeroing fixtures. At the testing temperature a compression molded sample disk is inserted between the plates and allowed to come to equilibrium for 5 minutes. The upper plate is then lowered down to 50 μm above the desired testing gap (1.5 mm). Any superfluous material is trimmed off and the upper plate is lowered to the desired gap. Measurements are done under nitrogen purging at a flow rate of 5 L/min. Default creep time is set for 2 hours.

A constant low shear stress of 20 Pa is applied for all of the samples to ensure that the steady state shear rate is low enough to be in the Newtonian region. The resulting steady state shear rates are in the range of 10⁻³ to 10⁻⁴ s⁻¹ for the samples in this study. Steady state is determined by taking a linear regression for all the data in the last 10% time window of the plot of log (J(t)) vs. log(t), where J(t) is creep compliance and t is creep time. If the slope of the linear regression is greater than 0.97, steady state is considered to be reached, then the creep test is stopped. The steady state shear rate is determined from the slope of the linear regression of all of the data points in the last 10% time window of the plot of ε vs. t, where ε is strain. The zero-shear viscosity is determined from the ratio of the applied stress to the steady state shear rate.

In order to determine if the sample is degraded during the creep test, a small amplitude oscillatory shear test is conducted before and after the creep test on the same specimen from 0.1 to 100 rad/s. The complex viscosity values of the two tests are compared. If the difference of the viscosity values at 0.1 rad/s is greater than 5%, the sample is considered to have degraded during the creep test, and the result is discarded.

If the viscosity difference is greater than 5%, a fresh or new sample (i.e., one that a viscosity test has not already been run on) is stabilized and the testing on this new stabilized sample is then run by the Creep Zero Shear Viscosity Method. This was done for IE1. The stabilization method is described herein. The desired amount of pellets to stabilize are weighed out and reserved for later use. The ppm of antioxidants are weighed out in a flat bottom flask with a screen lid or secured screen cover. The amount of antioxidants used are 1500 ppm Irganox 1010 and 3000 ppm Irgafos 168. Add enough acetone to the flask to generously cover the additives, approximately 20 ml. Leave the flask open. Heat the mixture on a hotplate until the additives have dissolved, swirling the mixture occasionally. The acetone will heat up quickly and the swirling will help it to dissolve. Do not attempt to bring it to a boil. Turn the hot plate off and move the flask to the other end of the hood. Gently add the pellets to the flask. Swirl the hot solution so as to wet all sides of the pellets. Slowly add more acetone. Generously cover the pellets with extra acetone but leave a generous amount of head space so that when the flask is put in the vacuum oven the solution will not come out of the flask. Cover the flask with a screen allowing it to vent while ensuring the pellets/solution will not come out. Place the flask in a pan, in a 50° C. vacuum oven. Close the oven and crack the nitrogen open slowly. After 30 minutes to 2 hours (30 minutes is sufficient for very small amounts e.g. 10 g of pellets), very slowly apply the vacuum and adjust the nitrogen flow so that you have a light sweep. Leave under 50° C. vacuum with N2 sweep for approximately 14 hours. Remove from oven. The pellets may be easier to remove from the flask while still warm. Rewet pellets with a small amount of acetone only if necessary for removal.

Zero-shear viscosity ratio (ZSVR) is defined as the ratio of the zero-shear viscosity (ZSV) of the branched polyethylene material to the ZSV of the linear polyethylene material at the equivalent weight average molecular weight (Mw-gpc) as shown in the Equation 10, as below:

$${M}_{w} ( cc ) = \frac{{\sum }_{i} {RI}_{i} * {M}_{cc , i}}{{\sum }_{i} {RI}_{i}} . \qquad Equation 10$$

The ZSV value is obtained from creep test at 190° C. via the method described above. The Mw-gpc value is determined by the conventional GPC method as described above. The correlation between ZSV of linear polyethylene and its Mw-gpc was established based on a series of linear polyethylene reference materials. A description for the ZSV-Mw relationship can be found in the ANTEC proceeding: Karjala, Teresa P.; Sammler, Robert L.; Mangnus, Marc A.; Hazlitt, Lonnie G.; Johnson, Mark S.; Hagen, Charles M., Jr.; Huang, Joe W. L.; Reichek, Kenneth N. Detection of low levels of long-chain branching in polyolefins. Annual Technical Conference—Society of Plastics Engineers (2008), 66th 887-891.

### Melt Strength

Melt strength is measured at 190° C. using a Goettfert Rheotens 71.97 (Goettfert Inc.; Rock Hill, S.C.), melt fed with a Goettfert Rheotester 2000 capillary rheometer equipped with a flat entrance angle (180 degrees) of length of 30 mm and diameter of 2 mm. The pellets are fed into the barrel (L=300 mm, Diameter=12 mm), compressed and allowed to melt for 10 minutes before being extruded at a constant piston speed of 0.265 mm/s, which corresponds to a wall shear rate of 38.2 s⁻¹ at the given die diameter. The extrudate passes through the wheels of the Rheotens located at 100 mm below the die exit and is pulled by the wheels downward at an acceleration rate of 2.4 mm/s². The force (in cN) exerted on the wheels is recorded as a function of the velocity of the wheels (in mm/s). Melt strength is reported as the plateau force (cN) before the strand broke.

### TREF Column

The TREF columns are constructed from acetone-washed ⅛ inch×0.085 inch 316 stainless steel tubing. The tubing is cut to a length of 42 inches and packed with a dry mixture (60:40 volume:volume) of pacified 316 stainless steel cut wire of 0.028 inch diameter (Pellet Inc., North Tonawanda, N.Y.) and 30-40 mesh spherical technical grade glass beads. This combination of column length and packing material results in an interstitial volume of approximately 1.75 mL. The TREF column ends are capped with Valco microbore HPLC column end fittings equipped with a 10 μm stainless steel screen. These column ends provide the TREF columns with a direct connection to the plumbing of the cross fractionation instrument within the TREF oven. The TREF columns are coiled, outfitted with an resistance temperature detector (RTD) temperature sensor, and wrapped with glass insulation tape before installation. During installation, extra care is given to level placement of the TREF column with the oven to ensure adequate thermal uniformity within the column. Chilled air is provided at 40 L/min to the TREF ovens via a chiller whose bath temperature is 2° C.

### TREF Column Temperature Calibration

The reported elution temperatures from the TREF column are adjusted with the heating rate used in the temperature range of 110° C. to 30° C. such that the observed compositions versus elution temperatures agree with those previously reported (L. Wild, R. T. Ryle et al., J. Polymer Science Polymer Physics Edition 20, 441-455(1982)).

### Sample Preparation

The sample solutions are prepared as 4 mg/mL solutions in 1,2,4-trichlorobenzene (TCB) containing 180 ppm butylated hydroxytoluene (BHT) and the solvent is sparged with nitrogen. A small amount of decane is added as a flow rate marker to the sample solution for GPC elution validation. Dissolution of the samples is completed by gentle stirring at 145° C. for four hours.

### Sample Loading

Samples are injected via a heated transfer line to a fixed loop injector (Injection loop of 500 μL) directly onto the TREF column at 145° C.

### Temperature Profile of TREF Column

After the sample has been injected onto the TREF column, the column is taken “off-line” and allowed to cool. The temperature profile of the TREF column is as follows: cooling down from 145° C. to 110° C. at 1.2° C./min, cooling down from 110° C. to 30° C. at 0.133° C./min, and thermal equilibrium at 30° C. for 30 minutes. During elution, the column is placed back “on-line” to the flow path with a pump elution rate of 0.9 ml/min for 1.0 minute. The heating rate of elution is 0.099° C./min from 30° C. to 105° C.

Elution from TREF Column

The 16 fractions are collected from 30° C. to 110° C. at 5° C. increments per fraction. Each fraction is injected for GPC analysis. Each of the 16 fractions are injected directly from the TREF column over a period of 1.0 minute onto the GPC column set. The eluent is equilibrated at the same temperature as the TREF column during elution by using a temperature pre-equilibration coil (Gillespie and Li Pi Shan et al., Apparatus for Method for Polymer Characterization, WO2006081116). Elution of the TREF is performed by flushing the TREF column at 0.9 ml/min for 1.0 min. The first fraction, Fraction (30° C.), represents the amount of material remaining soluble in TCB at 30° C. Fraction (35° C.), Fraction (40° C.), Fraction (45° C.), Fraction (50° C.), Fraction (55° C.), Fraction (60° C.), Fraction (65° C.), Fraction (70° C.), Fraction (75° C.), Fraction (80° C.), Fraction (85° C.), Fraction (90° C.), Fraction (95° C.), Fraction (100° C.), and Fraction (105° C.) represent the amount of material eluting from the TREF column with a temperature range of 30.01 to 35° C., 35.01 to 40° C., 40.01 to 45° C., 45.01 to 50° C., 50.01 to 55° C., 55.01 to 60° C., 60.01 to 65° C., 65.01 to 70° C., 70.01 to 75° C., 75.01 to 80° C., 80.01 to 85° C., 85.01 to 90° C., 90.01 to 95° C., 95.01 to 100° C., and 100.01 to 105° C., respectively.

### GPC Parameters

The cross fractionation instrument is equipped with one 10 μm guard column and four Mixed B-LS 10 μm columns (Varian Inc., previously PolymerLabs), and the IR-4 detector from PolymerChar (Spain) is the concentration detector. The GPC column set is calibrated by running twenty one narrow molecular weight distribution polystyrene standards. The molecular weight (MW) of the standards ranges from 580 to 8,400,000 g/mol, and the standards are contained in 6 “cocktail” mixtures. Each standard mixture (“cocktail”) has at least a decade of separation between individual molecular weights. The standards are purchased from Polymer Laboratories (Shropshire, UK). The polystyrene standards are prepared at 0.025 g in 50 mL of solvent for molecular weights equal to or greater than 1,000,000 g/mol and 0.05 g in 50 mL of solvent for molecular weights less than 1,000,000 g/mol. The polystyrene standards are dissolved at 145° C. with gentle agitation for 30 minutes. The narrow standards mixtures are run first and in the order of decreasing highest molecular weight component to minimize degradation. A logarithmic molecular weight calibration is generated using a first-order polynomial fit as a function of elution volume. The polystyrene standard peak molecular weights are converted to polyethylene molecular weights using Equation 8 as described in Williams and Ward, J. Polym. Sci., Polym. Let., 6, 621 (1968) where M is the molecular weight, A has a value of 0.40 and B is equal to 1.0.

The plate count for the four Mixed B-LS 10 μm columns needs to be at least 19,000 by using a 500 μl injection volume of a drop of a 50:50 mixture of decane and 1,2,4-trichlorobenzene (TCB) in 25 mL of TCB bypassing the TREF column. The plate count calculates from the peak retention volume (RV_{pk max}) and the retention volume (RV) width at ½ height (50% of the chromatographic peak) to obtain an effective measure of the number of theoretical plates in the column by using Equation 11 as shown below and as set forth in Striegel and Yau et al., “Modern Size-Exclusion Liquid Chromatography”, Wiley, 2009, Page 86:

Plate Count=5.54*[RV_{pk max}/(RV_{Rear 50% pk ht}−RV_{Front 50% pk ht})]² Equation 11

### MWD Analysis for Each Fraction

The molecular weight distribution (MWD) of each fraction is calculated from the integrated GPC chromatogram to obtain the weight average molecular weight for each fraction, MW (Temperature).

The establishment of the upper integration limit (high molecular weight end) is based on the visible difference between the peak rise from the baseline. The establishment of the lower integration limit (low molecular weight end) is viewed as the return to the baseline.

The area of each individual GPC chromatogram corresponds to the amount of polyolefinic material eluted from the TREF fraction. The weight percentage of the TREF fraction at a specified temperature range of the Fraction, Wt % (Temperature), is calculated as the area of the individual GPC chromatogram divided by the sum of the areas of the 16 individual GPC chromatograms. The GPC molecular weight distribution calculations (Mn, Mw, and Mz) are performed on each chromatogram and reported only if the weight percentage of the TREF fraction is larger than 1.0 wt %. The GPC weight-average molecular weight, Mw, is reported as MW (Temperature) of each chromatogram.

Wt % (30° C.) represents the amount of material eluting from the TREF column at 30° C. during the TREF elution process. Wt % (35° C.), Wt % (40° C.), Wt % (45° C.), Wt % (50° C.), Wt % (55° C.), Wt % (60° C.), Wt % (65° C.), Wt % (70° C.), Wt % (75° C.), Wt % (80° C.), Wt % (85° C.), Wt % (90° C.), Wt % (95° C.), Wt % (100° C.), and Wt % (105° C.) represent the amount of material eluting from the TREF column with a temperature range of 30.01° C. to 35° C., 35.01° C. to 40° C., 40.01 to 45° C., 45.01° C. to 50° C., 50.01° C. to 55° C., 55.01° C. to 60° C., 60.01° C. to 65° C., 65.01° C. to 70° C., 70.01° C. to 75° C., 75.01° C. to 80° C., 80.01° C. to 85° C., 85.01° C. to 90° C., 90.01° C. to 95° C., 95.01° C. to 100° C., and 100.01° C. to 105° C., respectively. The cumulative weight fraction is defined as the sum of the Wt % of the fractions up to a specified temperature. The cumulative weight fraction is 1.00 for the whole temperature range.

The highest temperature fraction molecular weight, MW (Highest Temperature Fraction), is defined as the molecular weight calculated at the highest temperature containing more than 1.0 wt % material. The MW Ratio of each temperature is defined as the MW (Temperature) divided by MW (Highest Temperature Fraction).

### ¹H NMR Method

3.26 g of stock solution is added to 0.133 g of polyolefin sample in 10 mm NMR tube. The stock solution is a mixture of tetrachloroethane-d₂ (TCE) and perchloroethylene (50:50, w:w) with 0.001M Cr³⁺. The solution in the tube is purged with N2 for 5 minutes to reduce the amount of oxygen. The capped sample tube is left at room temperature overnight to swell the polymer sample. The sample is dissolved at 110° C. with shaking. The samples are free of the additives that may contribute to unsaturation, e.g. slip agents such as erucamide.

The ¹H NMR are run with a 10 mm cryoprobe at 120° C. on Bruker AVANCE 400 MHz spectrometer.

Two experiments are run to get the unsaturation: the control and the double presaturation experiments.

For the control experiment, the data is processed with exponential window function with LB=1 Hz, baseline was corrected from 7 to −2 ppm. The signal from residual ¹H of TCE is set to 100, the integral Iₜₒₜₐₗ from −0.5 to 3 ppm is used as the signal from whole polymer in the control experiment. The number of CH₂ group, NCH₂, in the polymer is calculated as following:

NCH₂=Iₜₒₜₐₗ/2

For the double presaturation experiment, the data is processed with exponential window function with LB=1 Hz, baseline was corrected from 6.6 to 4.5 ppm. The signal from residual ₁H of TCE is set to 100, the corresponding integrals for unsaturations (I_{vinylene}, I_{trisubstituted}, I_{vinyl} and I_{vinylidene}) were integrated. The number of unsaturation units for vinylene, trisubstituted, vinyl and vinylidene are calculated:

N_{vinylene}=I_{vinylene}/2

N_{trisubstituted}═I_{trisubstituted}

N_{vinyl}=I_{vinyl}/2

N_{vinylidene}=I_{vinylidene}/2

The unsaturation unit/1,000,000 carbons is calculated as following:

N_{vinylene}/1,000,000C═(N_{vinylene}/NCH₂)*1,000,000

N_{trisubstituted}/1,000,000C═(N_{trisubstituted}/NCH₂)*1,000,000

N_{vinyl}/1,000,000C═(N_{vinyl}/NCH₂)*1,000,000

N_{vinylidene}/1,000,000C═(N_{vinylidene}/NCH₂)*1,000,000

The requirement for unsaturation NMR analysis includes: level of quantitation is 0.47±0.02/1,000,000 carbons for Vd2 with 200 scans (less than 1 hour data acquisition including time to run the control experiment) with 3.9 wt % of sample (for Vd2 structure, see Macromolecules, vol. 38, 6988, 2005), 10 mm high temperature cryoprobe. The level of quantitation is defined as signal to noise ratio of 10.

The chemical shift reference is set at 6.0 ppm for the ¹H signal from residual proton from TCT-d2. The control is run with ZG pulse, TD 32768, NS 4, DS 12, SWH 10,000 Hz, AQ 1.64 s, D1 14 s. The double presaturation experiment is run with a modified pulse sequence, O1P 1.354 ppm, O2P 0.960 ppm, PL9 57 db, PL21 70 db, TD 32768, NS 200, DS 4, SWH 10,000 Hz, AQ 1.64 s, D1 1 s, D13 13 s.

### Extensional Viscosity

Extensional viscosity was measured by an extensional viscosity fixture (EVF) of TA Instruments (New Castle, Del.), attached onto a model ARES rheometer of TA Instruments. Extensional viscosity at 150° C., and at Hencky strain rates of 10 s⁻¹, 1 s⁻¹ and 0.1 s⁻¹, was measured. A sample plaque was prepared on a programmable Tetrahedron model MTP8 bench top press. The program held 3.8 grams of the melt at 180° C., for five minutes, at a pressure of 1×10⁷ Pa, to make a “75 mm×50 mm” plaque with a thickness from 0.7 mm to 1.1 mm. The TEFLON coated chase containing the plaque was then removed to the bench top to cool. Test specimens were then die-cut from the plaque using a punch press and a handheld die with the dimensions of “10×18 mm (Width×Length).” The specimen thickness was in the range of about 0.7 mm to about 1.1 mm.

The rheometer oven that encloses the EVF fixture was set to a test temperature of 150° C., and the test fixtures that contact the sample plaque were equilibrated at this temperature for at least 60 minutes. The test fixtures were then “zeroed” by using the test software, to cause the fixtures to move into contact with each other. Then the test fixtures were moved apart to a set gap of 0.5 mm. The width and the thickness of each plaque were measured at three different locations on the plaque with a micrometer, and the average values of the thickness and width were entered into the test software (TA Orchestrator version 7.2). The measured density of the sample at room temperature was entered into the test software. For each sample, a value of “0.782 g/cc” was entered for the density at 150° C. These values are entered into the test software to allow calculation of the actual dimensions of the plaque at the test temperature. The sample plaque was attached, using a pin, onto each of the two drums of the fixture. The oven was then closed, and the temperature was allowed to equilibrate to 150° C.±0.5° C. As soon as the temperature entered this range, a stopwatch was manually started, and after 60 seconds, the automated test was started by clicking the software “Begin Test” button.

The test was divided into three automated steps. The first step was a “pre-stretch step” that stretched the plaque at a very low strain rate of 0.005 s⁻¹ for 11 seconds. The purpose of this step was to reduce plaque buckling, introduced when the plaque was loaded, and to compensate for the thermal expansion of the sample, when it was heated above room temperature. This step was followed by a “relaxation step” of 60 seconds, to minimize the stress introduced in the pre-stretch step. The third step was the “measurement step,” where the plaque was stretched at the pre-set Hencky strain rate. The data collected in the third step was stored, and then exported to Microsoft Excel, where the raw data was processed into the Strain Hardening Factor (SHF) values reported herein.

### Shear Viscosity for Strain Hardening

### Sample Preparation for Shear Viscosity Measurement

Specimens for shear viscosity measurements were prepared on a programmable Tetrahedron model MTP8 bench top press. The program held 2.5 grams of the melt at 180° C., for five minutes, in a cylindrical mold, at a pressure of 1×10′ Pa, to make a cylindrical part with a diameter of 30 mm and a thickness of 3.5 mm. The chase was then removed to the bench top to cool down to room temperature. Round test specimens were then die-cut from the plaque using a punch press and a handheld die with a diameter of 25 mm. The specimen was about 3.5 mm thick.

### Shear Viscosity Measurement

Shear viscosity (Eta*) was obtained from a steady shear start-up measurement that was performed with the model ARES rheometer of TA Instruments, at 150° C., using “25 mm parallel plates” at a gap of 2.0 mm, and under a nitrogen purge. In the steady shear start-up measurement, a constant shear rate of 0.005 s⁻¹ was applied to the sample for 100 seconds. Shear viscosities were collected as a function of time in the logarithmic scale. A total of 200 data points were collected within the measurement period. The Strain Hardening Factor (SHF) is the ratio of the extensional viscosity to three times of the shear viscosity, at the same measurement time and at the same temperature.

### Additives Determination

Additive levels, such as the Irgafos 168 level, may be determined as in:

Standard Test Method for Determination of Antioxidants and Erucamide Slip Additives in Polyethylene Using Liquid Chromatography (LC); ASTM D6953-11, ASTM International: 2011. Standard Practice for Extraction of Additives in Polyolefin Plastics; ASTM D7210-13; ASTM International: 2013.

### Film Testing Conditions

The following physical properties are measured on the films produced:
Total (Overall), Surface and Internal Haze: Samples measured for internal haze and overall haze are sampled and prepared according to ASTM D 1003. Internal haze was obtained via refractive index matching using mineral oil on both sides of the films. A Hazeguard Plus (BYK-Gardner USA; Columbia, Md.) is used for testing. Surface haze is determined as the difference between overall haze and internal haze.
45° Gloss: ASTM D-2457.
MD and CD Elmendorf Tear Strength: ASTM D-1922.
MD and CD Tensile Strength: ASTM D-882.
Dart Impact Strength: ASTM D-1709.
Puncture: Puncture is measured on an Instron Model 4201 with Sintech Testworks Software Version 3.10. The specimen size is 6 inch×6 inch and 4 measurements are made to determine an average puncture value. The film is conditioned for 40 hours after film production and at least 24 hours in an ASTM controlled laboratory. A 100 lb load cell is used with a round specimen holder. The specimen is a 4 inch circular specimen. The puncture probe is a ½ inch diameter polished stainless steel ball (on a 0.25 inch rod) with a 7.5 inch maximum travel length. There is no gauge length; the probe is as close as possible to, but not touching, the specimen. The crosshead speed used is 10 inches/minute. The thickness is measured in the middle of the specimen. The thickness of the film, the distance the crosshead traveled, and the peak load are used to determine the puncture by the software. The puncture probe is cleaned using a “Kim-wipe” after each specimen.
Shrink tension is measured according to the method described in Y. Jin, T. Hermel-Davidock, T. Karjala, M. Demirors, J. Wang, E. Leyva, and D. Allen, “Shrink Force Measurement of Low Shrink Force Films”, SPE ANTEC Proceedings, p. 1264 (2008).
% Free Shrink: A single layer square film with a dimension of 10.16 cm×10.16 cm is cut out by a punch press from a film sample along the edges of the machine direction (MD) and the cross direction (CD). The film is then placed in a film holder and the film holder is immersed in a hot-oil bath at 150° C. for 30 seconds. The holder is then removed from the oil bath. After oil is drained out, the length of film is measured at multiple locations in each direction and the average is taken as the final length. The % free shrink is determined from Equation 12 as below:

$$\frac{Initial Length ) - ( Final Length )}{Initial Length} \times 100. \qquad Equation 12$$

The present invention may be embodied in other forms without departing from the spirit and the essential attributes thereof, and, accordingly, reference should be made to the appended claims, rather than to the foregoing specification, as indicating the scope of the invention.

We claim:

1. A polyethylene blend composition suitable for film applications comprising:
a. from 10 to 100 percent by weight of an ethylene-based polymer made by the process which comprises:
i. selecting an ethylene/α-olefin interpolymer (LLDPE) having a Comonomer Distribution Constant (CDC) from 75 to 300, a vinyl unsaturation of less than 150 vinyls per one million carbon atoms of the ethylene-based polymer composition; a zero shear viscosity ratio (ZSVR) from 4 to 50; a density from 0.925 to 0.950 g/cm³, a melt index (I₂) from 0.1 to 2.5 g/10 minutes, a molecular weight distribution (M_{w}/Mₙ) from 1.8 to 4;
ii. reacting the ethylene/α-olefin interpolymer with an alkoxy amine derivative in an amount less than 900 parts derivative per million parts by weight of total ethylene/α-olefin interpolymer under conditions sufficient to increase the melt strength of the target polyethylene resin; and
b. optionally from 5 to 90 percent by weight of a low density polyethylene composition.

2. A film comprising a layer made from the polyethylene blend composition according to claim 1.

3. The film consisting essentially of the polyethylene blend composition according to claim 1.

4. The film according to claim 3 wherein the film has a thickness of 2±0.2 mil.

5. The film according to claim 4, wherein the film exhibits a total haze of equal to or less than 17%.

6. The film according to claim 4, wherein the film exhibits an MD shrink tension of at least 16 psi.

7. The film according to claim 4, wherein the film exhibits a CD shrink tension of at least 1 psi.

8. The film according to claim 4, wherein the film exhibits a puncture of at least 85 ft-lb/in³.

9. The polyethylene blend composition according to claim 1 further comprising from 500 to 2000 ppm secondary oxidant based on the total polymeric composition weight.

10. The polyethylene blend composition according to claim 1 wherein the ethylene-based polymer has a melt strength from 2 to 20 cN.
